(19) United States
(12) Patent Application Publication
(10) Pub. No.: US 2026/0094312 A1
(43) Pub. Date: Apr. 2, 2026

(54) METHODS FOR GENERATING REMOTE SENSING IMAGE FROM TEXT

(71) Applicant: GUILIN UNIVERSITY OF TECHNOLOGY, Guilin (CN)

(72) Inventors: Guoqing ZHOU, Guilin (CN); Weiyi WANG, Guilin (CN)

(73) Assignee: GUILIN UNIVERSITY OF TECHNOLOGY, Guilin (CN)

(21) Appl. No.: 19/300,626

(22) Filed: Aug. 14, 2025

(30) Foreign Application Priority Data
Sep. 29, 2024 (CN) 202411364238.2

(51) Int. Cl. G06T 11/00

(52) U.S. Cl. CPC G06T 11/00

(57) ABSTRACT

A method for generating a remote sensing image from a text is provided. The method parses textual descriptions and utilizes dynamic hierarchical prototype blocks for hierarchical prototype learning and dynamic prototype learning to generate the remote sensing image of high quality. For example, text-image pairs are processed through encoders to obtain text tokens and image tokens. A concatenated joint sequence of the text tokens and image tokens are input into dynamic hierarchical prototype layers for feature extraction. By combining Hopfield networks with a self-attention mechanism, the memory and information retrieval capabilities of the model are enhanced, thereby improving richness and accuracy of feature representation of the remote sensing image. Furthermore, a dynamic prototype learning strategy is adopted, which enables the model to learn and adapt to more prototypes, exhibiting robustness and accuracy when processing complex data. The remote sensing images are visually consistent with textual descriptions while maintaining high-quality details.

### CROSS-REFERENCE TO RELATED APPLICATIONS

This application n claims priority to Chinese Patent Application No. 202411364238.2, filed on Sep. 29, 2024, the entire contents of which are hereby incorporated by reference.

### TECHNICAL FIELD

The present disclosure relates to the field of remote sensing technology and artificial intelligence, and in particular, relates to a method for generating a remote sensing image from a text.

### BACKGROUND

Remote sensing images are regarded as “spectral snapshots” of the Earth and are important earth observation data. The remote sensing images can be used to generate a wide range of real-time data remotely, and play a key role in areas such as land and urban planning, environmental monitoring, military target identification, etc. With the advancement of technology, substantial progress has been made in understanding remote sensing images, and advances in geographic information systems (GIS) have facilitated the visualization of remotely sensed data. Additionally, the development of machine learning and artificial intelligence enables the transformation of textual descriptions into highly semantically relevant images, connecting natural language with computer vision, and driving the advancement of artificial intelligence in “understanding.”

As widely recognized in the field, there are significant differences in view and content between natural images and remote sensing images. Remote sensing images present complex and diverse data, requiring a broad understanding of the interactions between various geographic aspects and phenomena. Natural images are recorded from a horizontal perspective, where the foreground and background are readily apparent to the human eye, and the protagonists in the image often occupies most of the area, making it easy to identify. On the other hand, remote sensing images are recorded in vertical view (nadir perspective), exhibiting higher object density and scene complexity. The foreground and background are difficult to distinguish, and salient objects in the image exhibit comparable dimensions to the background and may even become visually embedded within it, making detection challenging even for human observers. These factors make generating remote sensing images more difficult than generating natural images. In addition, with the explosive growth of remote sensing data, it remains a challenge for traditional remote sensing image processing techniques to create the desired content without tedious manual operations.

Despite recent successes in generating natural images from text, the generating high-resolution remote sensing images from text remains challenging. Bejiga et al. proposed the first work dealing with the generating remote sensing images from text, in which conditional GAN is applied to generate ultra-low spatial resolution grayscale remote sensing images from textual descriptions of ancient geographic regions. They later improved text encoding by using a pre-trained Doc2Vec encoder to capture different levels of information in the input text. However, these methods generated grayscale remote sensing images with very low spatial resolution and missed many details. Chen et al. further proposed a text-based deep supervised GAN to generate satellite images with a spatial size of 128×128, and utilized the generated images to enhance the training set for the change detection task. Zhao et al. proposed a structured GAN to synthesize remote sensing images from text with a spatial size of 256×256, emphasizing that structural information is an important factor in assessing the fidelity of the generated images. Xu et al. proposed using contemporary Hopfield networks to generate high-resolution remote sensing images from text. However, due to the difficulty in identifying and understanding foreground elements in remote sensing images, as well as the complex and diverse spatial distribution of different land features, and the fact that text descriptions and remote sensing images have completely different modal information, the performance of the above methods is limited, and it is still very difficult to generate high-quality and authentic remote sensing images from text descriptions.

Therefore, it is necessary to provide a method for generating a remote sensing image from a text to improve the richness and accuracy of the feature representations of remote sensing images, and to demonstrate higher robustness and accuracy when processing complex data.

### SUMMARY

One or more embodiments of the present disclosure provide a method for generating a remote sensing image from a text. The method includes:
S1, preparing a remote sensing image captioning dataset (RSICD), obtaining a textual description and a real remote sensing image corresponding to the textual description;
S2, training a vector quantization generation adversarial network (VQGAN);
S3, encoding text-image pairs through a text encoder and an image encoder;
S4, concatenating text tokens and image tokens;
S5, inputting a concatenated joint sequence into dynamic hierarchical prototype blocks for feature extraction;
S6, using a dynamic prototype learning strategy during the training of the VQGAN; and
S7, generating the remote sensing image using the trained VQGAN.

In some embodiments, the operation S1 includes: extracting a textual description of each image into a separate txt file. An input is a raw json file of the RSICD, and an output is a txt file that contains all the textual descriptions, names of all training sample files, and names of all test sample files.

In some embodiments, the operation S2 includes: pre-generating a Codebook Z of discrete values. The Codebook Z is represented by

$$Codebook 𝒵 = {\{ {z}_{k} \}}_{k = 1}^{K} ,$$

wherein zₖ∈ [symbol] ⁿ^{_{z}}. For each coding position of \hat{z}, a code with a shortest distance to the coding position is identified in the Codebook Z, and variables of the same dimension are generated. Encoding is performed using a CNN Encoder, which is represented by the following formula (1):

$$\hat{x} = G ( {z}_{q} ) = G ( q ( E ( x ) ) ) . \qquad ( 1 )$$

A self-supervised loss is represented by the following formula (2):

$${ℒ}_{VQ} ( E , G , Z , ) = {‖ x - \hat{x} ‖}^{2} + {‖ sg [ E ( x ) ] - {z}_{q} ‖}^{2} + {‖ sg ( {z}_{q} ) - E ( x ) ‖}^{2} , \qquad ( 2 )$$

wherein in the formula (2), [symbol] _{rec} represents a reconstruction loss and sg(⋅) represents a stop-gradient operation. Additionally, an adversarial loss from a GAN is incorporated. The loss function of the GAN is represented by the following formula (3):

$${ℒ}_{VQ} ( \{ E , G , Z \} , D ) = log D ( x ) + log ( 1 - D ( \hat{x} ) ) . \qquad ( 3 )$$

In summary, that is:

$$x \to \hat{z} \to {z}_{q} \to \hat{x} . \qquad ( 4 )$$

In some embodiments, the operation S3 includes that (1) each character in the text is designated as an independent token, frequencies of all character pairs are determined, most frequent character pairs are merged to form a new token, and the above operations are repeated until a preset token count is reached. n is set to denote a maximum length of an input sentence, if a word count of an input text description is less than n, zero is used as a placeholder to pad empty tokens, an input text is converted into the text tokens using Byte Pair Encoding (BPE), and the text tokens are converted into vector representations using a pre-trained word embedding model. The operation S3 further includes that (2) an input image is converted into the image tokens using a pre-trained image encoder, and the image tokens are converted into vector representations. The text and information of the image are converted into a unified token representation through the above operations.

In some embodiments, the operation S4 includes that the text tokens and the image tokens are concatenated in an order in which the text tokens precede the image tokens, to form the concatenated joint sequence, and a positional encoding is added to each token in the concatenated joint sequence to help the model understand the relative positional relationships between the tokens.

In some embodiments, the operation S5 includes: inputting a concatenated joint sequence into a LayerScale layer and a PreNorm layer of a first dynamic hierarchical prototype block for normalization and scaling; inputting a normalized and scaled concatenated joint sequence into Hopfield layers with a temperature parameter, wherein the Hopfield layers store and retrieve representative prototypes through minimization of an energy function; inputting the concatenated joint sequence processed by the Hopfield layers into hierarchical prototype layers.

After being input into the hierarchical prototype layers, the concatenated joint sequence first passes through a first Hopfield layer for information storage and retrieval. Then, the concatenated joint sequence proceeds to a first self-attention layer to capture dependencies between different positions in the concatenated joint sequence. Subsequently, the concatenated joint sequence proceeds to a second Hopfield layer for further refining feature representations, and finally reaches a second self-attention layer to enhance feature interactions. During forward propagation, input data is processed sequentially through these hierarchical structures, with a final output integrating feature representations from each layer. The output is expressed as formula (5):

$$HeirarchicalPrototypeLayer ( x ) = S {A}_{2} ( {H}_{2} ( S {A}_{1} ( {H}_{1} ( x ) ) ) ) , \qquad ( 5 )$$

wherein in formula (5), H₁ represents the first Hopfield layer, H₂ represents the second Hopfield layer, SA₁ represents a self-attention layer of the first Hopfield layer, SA₂ represents a self-attention layer of the second Hopfield layer.

A plurality of hierarchical prototype layers may be integrated in a plurality of dynamic hierarchical prototype blocks, wherein each of the dynamic hierarchical prototype blocks includes two hierarchical prototype layers, two standard Hopfield layers, and two self-attention layers, which is represented by the following formula (6):

$$P ( x ) = x + {\sum }_{i = 1}^{{n}_{blk}} ( L {S}_{i} ( P N ( H L ( x ) ) ) + H P L ( x ) + L {S}_{i} ( P N ( S A ( x ) ) ) + H P L ( x ) ) , \qquad ( 6 )$$

wherein P represents the dynamic hierarchical prototype blocks, LS represents a LayerScale layer, PN represents a PreNorm layer, HL represents the Hopfield layers, HPL represents the hierarchical prototype layers, SA represents the self-attention layers, and n_{blk} represents a count of prototypes.

A concatenated joint sequence processed by the dynamic hierarchical prototype block is input into the LayerScale layer and the PreNorm layer for normalization and scaling. The normalized and scaled concatenated joint sequence is input into the self-attention layer to determine a similarity among a query, a key, and a value vector. A long-range dependency within the concatenated joint sequence is captured. The concatenated joint sequence processed by the first dynamic hierarchical prototype block is input into the subsequent dynamic hierarchical prototype blocks sequentially.

In some embodiments, the operation S6 includes that during the training of the VQGAN, the VQGAN periodically (e.g., every 100 steps) generates images and determines a final confidence level of the images, wherein the final confidence level of the generated images refers to an average value of maximum prediction probabilities of the VQGAN for the generated images. First, the VQGAN generates the images based on the input textual description. Then, the VQGAN determines logits values of each of the images and converts the logits values of each of the images into a probability distribution via a softmax function, wherein the softmax function is represented by the following formula (7):

$$softmax ( {z}_{i} ) = \frac{{e}^{{z}_{i}}}{{\sum }_{j} {e}^{{z}_{i}}} , \qquad ( 7 )$$

wherein in formula (7), zᵢ represents an i-th logits value, a maximum value in the probability distribution is designated as a confidence level of the image, and an average value of confidence levels of the images is determined, the confidence level is determined using the following formula (8):

$$confidence = \frac{1}{N} {\sum }_{i = 1}^{N} max ( softmax ( {logits}_{i} ) ) , \qquad ( 8 )$$

wherein in formula (8), N denotes a count of samples, and logitsᵢ denotes the logits value of an i-th sample.

In some embodiments, the operation S7 includes: after processing through the hierarchical prototype layers, the VQGAN generates predicted image tokens Î={Î₁, Î₂, . . . , Îₘ}, and a generation process is expressed as Î=f(S), wherein f denotes a generation function of the VQGAN, and S denotes the concatenated joint sequence. A cross-entropy loss is determined between the predicted image tokens and original image tokens, and the cross-entropy loss is used to measure a difference between a predicted token and a true token. The cross-entropy loss is defined as the following formula (9):

$$L = - {\sum }_{i = 1}^{C} {y}_{i} log ( {\hat{y}}_{i} ) , \qquad ( 9 )$$

wherein in formula (9), yᵢ denotes a probability distribution of the original image tokens, ŷᵢ denotes a probability distribution of the predicted image tokens. The predicted image tokens may be input into a decoder network, which converts the predicted image tokens into image pixel values based on learned features, and generate the remote sensing image of high quality through a series of post-processing operations.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a flowchart illustrating an exemplary overall process for generating a remote sensing image from a text according to some embodiments of the present disclosure;

FIG. 2 is a flowchart illustrating an algorithm of an exemplary process for generating a remote sensing image from a text according to some embodiments of the present disclosure;

FIG. 3 is a schematic diagram illustrating an exemplary dynamic hierarchical prototype block in a process for generating a remote sensing image from a text according to some embodiments of the present disclosure; and

FIG. 4 is a schematic diagram illustrating an exemplary remote sensing image generated in a process for generating a remote sensing image from a text according to some embodiments of the present disclosure.

### DETAILED DESCRIPTION

In order to make the objectives, technical solutions, and advantages of the disclosure clearer and more comprehensible, the following describes implementations of this relevant disclosure in detail with reference to the accompanying drawings and exemplary embodiments.

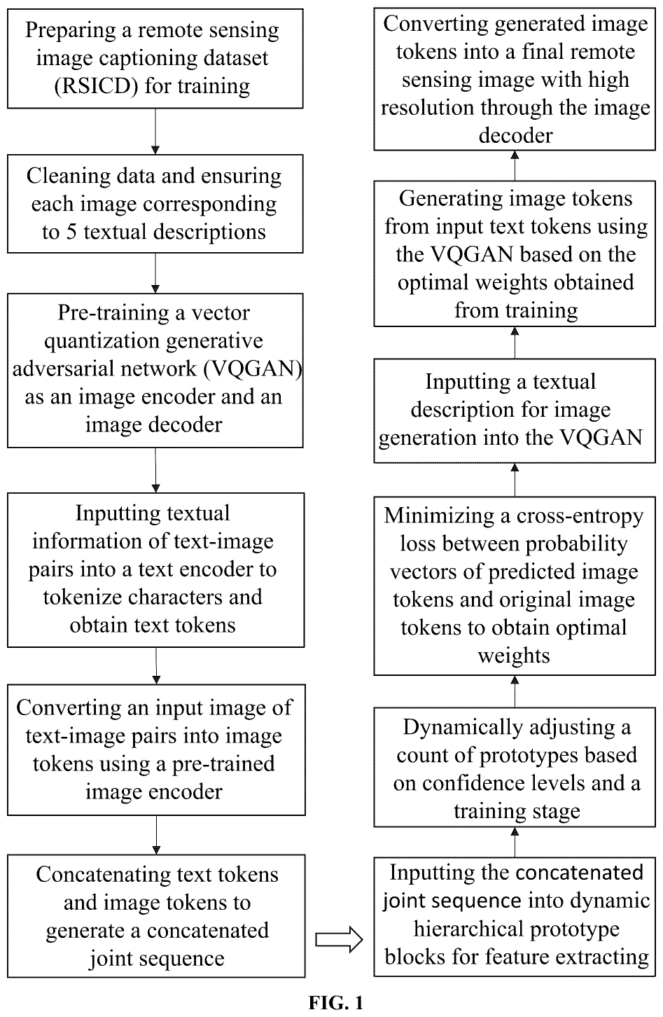

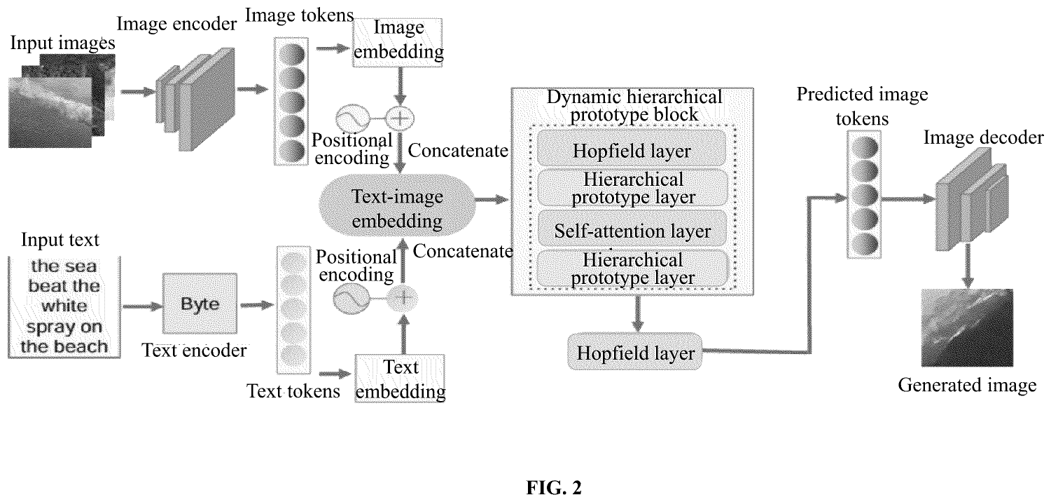

FIG. 1 is a flowchart illustrating an exemplary overall process for generating a remote sensing image from a text according to some embodiments of the present disclosure. FIG. 2 is a flowchart illustrating an algorithm of an exemplary process for generating a remote sensing image from a text according to some embodiments of the present disclosure.

As shown in FIG. 1-FIG. 2, one of the embodiments of the present disclosure provides a method for generating a remote sensing image from a text. The method includes operation S1-operation S7. In some embodiments, the method is executed by a processor. The processor refers to a hardware unit configured to execute instructions.

The processor may include one or more processing cores to process data in parallel. For example, the processor may be a central processing unit (CPU), a graphics processing unit (GPU), an application-specific integrated circuit (ASIC), or other hardware devices with computational capabilities. The processor may also include caches, registers, and other computational resources to increase processing efficiency. The processor can work in concert with other hardware components (e.g., memory, input/output interfaces, etc.) to accomplish data reading, processing, and output. The processor may perform a variety of computational tasks including, but not limited to, data encoding, feature extraction, model training, image generation, or the like.

In S1, a remote sensing image captioning dataset (RSICD) may be prepared, and a textual description and a real remote sensing image corresponding to the textual description may be obtained.

The RSICD was originally collected for a remote sensing image captioning task. The RSICD contains 30 scene classes with a total of 10,921 aerial remote sensing images of different resolutions. The size of each image of the aerial remote sensing images is 224×224 pixels, and each image is provided with five textual descriptions. 8,734 generated text-image pairs are used as a training set for the present disclosure, while the remaining 2,187 text-image pairs are used as a test set. All the aerial remote sensing images are resized to a resolution of 256×256.

In some embodiments, the operation S1 includes: extracting a textual description of each image into a separate txt file by using a customized data preprocessing script. An input of the customized data preprocessing script is a raw JSON file of the RSICD, and an output of the customized data preprocessing script is a TXT file that contains all the textual descriptions, names of all training sample files, and names of all test sample files.

In S2, a vector quantization generation adversarial network (VQGAN) may be trained.

A model (i.e., the VQGAN, also referred to as a VQGAN model) may include four parts, which are a CNN Encoder, a CNN Decoder, a Codebook, and a CNN Discriminator.

In the operation S2, an Adam optimizer with an initial learning rate of 1e-3 may be configured to train the VQGAN model. To optimize the learning process, an “exponential” learning rate decay strategy is adopted, that is, the learning rate is multiplied by 0.996 at the end of each training cycle (epoch). An entire training process runs for 1,000 epochs. Once the VQGAN (or VQGAN model) is trained, weight parameters in an encoder network, a decoder network, and a codebook are frozen.

In some embodiments, the operation S2 includes: pre-generating a Codebook Z of discrete values. The Codebook Z is represented by

$$Codebook 𝒵 = {\{ {z}_{k} \}}_{k = 1}^{K} ,$$

wherein zₖ∈ [symbol] ⁿ^{_{z}}. For each coding position of \hat{z}, a code with a shortest distance to the coding position is identified in the Codebook Z, and variables of the same dimension are generated. \hat{z} denotes a continuous feature extracted from an input image by the image encoder, which represents a quantized encoding result obtained by mapping to a discrete vector space through vector quantization operation. This encoding consists of a plurality of discrete vectors selected from the Codebook Z, reflecting a discrete semantic representation of the input image in the latent representation space and used for subsequent image reconstruction. Encoding is performed using a CNN Encoder, which is represented by the following formula (1):

$$\hat{x} = G ( {z}_{q} ) = G ( q ( E ( x ) ) ) . \qquad ( 1 )$$

A self-supervised loss is represented by the following formula (2):

$${ℒ}_{VQ} ( E , G , Z ) = {‖ x - \hat{x} ‖}^{2} + {‖ sg [ E ( x ) ] - {z}_{q} ‖}^{2} + {‖ sg ( {z}_{q} ) - E ( x ) ‖}^{2} , \qquad ( 2 )$$

wherein in the formula (2), [symbol] _{rec} represents a reconstruction loss and sg(⋅) represents a stop-gradient operation. Additionally, an adversarial loss from a GAN is incorporated. The loss function of the GAN is represented by the following formula (3):

$${ℒ}_{VQ} ( \{ E , G , Z \} , D ) = log D ( x ) + log ( 1 - D ( \hat{x} ) ) . \qquad ( 3 )$$

In summary, that is:

$$x \to \hat{z} \to {z}_{q} \to \hat{x} . \qquad ( 4 )$$

In S3, text-image pairs may be encoded through a text encoder and an image encoder.

In some embodiments, the operation S3 includes that (1) each character in the text is designated as an independent token, frequencies of all character pairs are determined, most frequent character pairs are merged to form a new token, and the above operations are repeated until a preset token count is reached. n is set to denote a maximum length of an input sentence, if a word count of an input text description is less than n, zero is used as a placeholder to pad empty tokens, an input text is converted into the text tokens using Byte Pair Encoding (BPE), and the text tokens are converted into vector representations using a pre-trained word embedding model. The operation S3 further includes that (2) an input image is converted into the image tokens using a pre-trained image encoder, and the image tokens are converted into vector representations. The text and information of the image are converted into a unified token representation through the above operations.

In some embodiments, the operation S3 further includes: performing random mask encoding on at least one geographic feature type in the text through the text encoder to exclude the at least one geographic feature type; concatenating the masked text tokens with corresponding image tokens to generate a concatenated vector; storing both the concatenated vector and the corresponding generated remote sensing image in a database.

The random mask encoding refers to randomly replacing one or more original elements in a sequence with a preset special placeholder.

In some embodiments, the text encoder performs random mask encoding on at least one geographic feature type in the text, that is, the text encoder randomly selects one or more geographic feature types in the text and replaces the one or more geographic feature types with preset special placeholders. For example, a preset special placeholder for “[ [symbol] [symbol] ]” may be “[MASK]”. After encoding an original text “scenery having mountains and lakes”, “[scenery] [having] [mountains] [and] [lakes]” are obtained. The text encoder identifies “[mountains]” and “[lakes]” as the geographic feature types, and randomly selects ‘[mountains]’ for mask encoding to generate a masked text as “[scenery] [having] [MASK] [and] [lakes]”.

The geographic feature type refers to a category of each type of geographic entity contained in the remote sensing image. For example, the geographic feature type may include, but is not limited to, a mountain, a lake, a tall building, or the like. In some embodiments, the processor may determine the geographic feature types by performing image recognition on the remote sensing images through image recognition technologies.

In some embodiments, the processor may concatenate the masked text tokens with the image tokens to generate a concatenated vector, and store both the concatenated vector and its corresponding remote sensing image in a database. More descriptions regarding concatenating the text tokens with the image tokens may be found in S4 and related descriptions thereof.

In some embodiments of the present disclosure, the model is forced to learn contextual relationships through masked text training, thereby enhancing the model's understanding of scene context. After such training, the model demonstrates improved robustness when processing incomplete or ambiguous textual instructions. Even when user descriptions contain omissions, the model can leverage its contextual reasoning capabilities to generate more logical and complete images.

In S4, text tokens and image tokens may be concatenated.

In some embodiments, the operation S4 includes that the text tokens and the image tokens are concatenated in an order in which the text tokens precede the image tokens, to form the concatenated joint sequence, and a positional encoding is added to each token in the concatenated joint sequence to help the model understand the relative positional relationships between the tokens.

The text token refers to a vector representing semantic information of words or characters in the text. The image token refers to a vector representing visual features of regions or objects within an image.

Text and image embedding includes: embedding layers are created for the text and images respectively, which are used to convert the text and images into high-dimensional vector representations. Assuming a count of the text tokens is Nₜ, a count of the image tokens is Eᵢ, and an embedding dimension is d, embedding matrices are represented by the following formula (10) and formula (11):

$${E}_{t} = Embedding ( {N}_{t} , d ) , \qquad ( 10 )$$

$${E}_{i} = Embedding ( {N}_{i} , d ) . \qquad ( 11 )$$

Position embedding includes: creating position embeddings for the text and images to capture positional information in sequences. Assuming a length of a text sequence is Nᵢ, and a length of an image sequence is Lᵢ, positional embedding matrices are represented by the following formula (11) and formula (12):

$${E}_{i} = Embedding ( {N}_{i} , d ) , \qquad ( 11 )$$

$${P}_{i} = AxialPositionalEmbedding ( d , axial shape = ( \sqrt{{L}_{i}} , \sqrt{{L}_{i}} ) ) . \qquad ( 12 )$$

VQGAN freezing includes: freezing the Vector Quantized Generative Adversarial Network (VQGAN) to prevent its parameters from being updated during training:
set_requires_grad (Gan,False).

In S5, a concatenated joint sequence may be input into dynamic hierarchical prototype blocks for feature extraction. The operation S5 includes: inputting the concatenated joint sequence into a first dynamic hierarchical prototype block for normalization and scaling; inputting a normalized and scaled concatenated joint sequence into Hopfield layers with a temperature parameter; inputting a concatenated joint sequence processed by the Hopfield layers into hierarchical prototype layers, wherein the hierarchical prototype layers are represented by the following formula (5):

$$HierarchicalPrototypeLayer ( x ) = {SA}_{2} ( {H}_{2} ( {SA}_{1} ( {H}_{1} ( x ) ) ) ) , \qquad ( 5 )$$

wherein in formula (5), H₁ represents a first Hopfield layer, H₂ represents a second Hopfield layer, SA₁ represents a self-attention layer of the first Hopfield layer, SA₂ represents a self-attention layer of the second Hopfield layer;

Each of the dynamic hierarchical prototype blocks includes two hierarchical prototype layers, two standard Hopfield layers, and two self-attention layers, which is represented by the following formula (6):

$$P ( x ) = \text{} x + \text{} {\sum }_{i = 1}^{{n}_{blk}} \text{} ( {LS}_{i} ( PN ( HL ( x ) ) ) + HPL ( x ) + {LS}_{i} ( PN ( SA ( x ) ) ) + HPL ( x ) ) , \qquad ( 6 )$$

wherein in formula (6), P represents the dynamic hierarchical prototype blocks, LS represents a LayerScale layer, PN represents a PreNorm layer, HL represents the Hopfield layers, HPL represents the hierarchical prototype layers, SA represents the self-attention layers, and n_{blk} represents a count of prototypes. The LayerScale (LS) layer refers to a layer that performs a learnable channel-by-channel scaling of an input feature, i.e., a scaling layer. The PreNorm (PN) layer refers to a layer that performs layer normalization on features before processing by subsequent sub-layers, i.e., a normalization layer.

Then, the concatenated joint sequence processed by the first dynamic hierarchical prototype block may be input into subsequent dynamic hierarchical prototype blocks sequentially. In some embodiments, a concatenated joint sequence processed by the dynamic hierarchical prototype block is input into the LayerScale layer and the PreNorm layer for normalization and scaling. The normalized and scaled concatenated joint sequence is input into the self-attention layer to determine a similarity among a query, a key, and a value vector. A long-range dependency within the concatenated joint sequence is captured. The concatenated joint sequence processed by the first dynamic hierarchical prototype block is input into the subsequent dynamic hierarchical prototype blocks sequentially.

A dynamic hierarchical prototype block is initialized for hierarchical prototype learning in latent space. Assuming a count of prototypes is Nₚ, a parameter of the dynamic hierarchical prototype block module is represented by the following formula (13):

$${W}_{p} = DPPrototypeBlock ( d , {L}_{t} + {L}_{i} , n\_block , heads , {dim}_{head} , {N}_{p} ) . \qquad ( 13 )$$

The hierarchical prototype layer may include four parts including: a first Hopfield layer for storing and retrieving information; a first self-attention layer for capturing dependencies between different positions in the sequence; a second Hopfield layer for further refining feature representation; a second self-attention layer for enhancing feature interactions. During forward propagation, input data is processed sequentially through these hierarchical structures, with a final output integrating feature representations from each layer.

Combining these definitions, the forward propagation process of the hierarchical prototype layer may be represented as follows: data x is input, and after being processed by the first Hopfield layer, the data is represented by the following formula (14):

$${x}_{1} = {Hopfield}_{1} ( x ) = HopfieldLayer ( x , num\_prototype ) , \qquad ( 14 )$$

wherein in formula (14), num_prototype represents a count of prototypes, the first Hopfield layer maps the input data to a high-dimensional space and stores it as a prototype.

The output x₁ of the first Hopfield layer is processed by the first self-attention layer, and the processed data is represented by the following formula (15):

$${x}_{2} = {SelfAttention}_{1} ( {x}_{1} ) = SelfAttention ( {x}_{1} , dim\_head ) . \qquad ( 15 )$$

The first self-attention layer aggregates the contextual information of the text by calculating a similarity between a plurality of tokens in the input sequence and other tokens through heads with dimension dim_head.

The output of the first Hopfield layer and the output of the first self-attention layer are summed and then passed to the second Hopfield layer as shown in the following formula (16):

$${x}_{3} = {Hopfield}_{2} ( {x}_{1} + {x}_{2} ) = HopfieldLayer ( {x}_{1} + {x}_{2} , \frac{{num}_{prototype}}{2} ) . \qquad ( 16 )$$

The second Hopfield layer further processes the input data to capture more complex patterns and features.

The output x₃ of the second Hopfield layer is processed by the second self-attention layer, and the processed data is represented by the following formula (17):

$${x}_{4} = {SelfAttention}_{2} ( {x}_{3} ) = SelfAttention ( {x}_{3} , \frac{dim\_head}{2} ) . \qquad ( 17 )$$

The second self-attention layer further aggregates contextual information to enhance expression ability of the model. Finally, the outputs of all layers are summed to obtain a final output represented by the following formula (18):

$$output - {x}_{1} + {x}_{2} + {x}_{3} + {x}_{4} . \qquad ( 18 )$$

In S6, a dynamic prototype learning strategy may be used during the training of the VQGAN model. Images are generated and a final confidence level is determined during and after the training process.

In some embodiments, the operation S6 includes that during the training of the VQGAN, the VQGAN periodically (e.g., every 100 steps) generates images and determines a final confidence level of the images, wherein the final confidence level of the generated images refers to an average value of maximum prediction probabilities of the VQGAN for the generated images. The model periodically generates images and determines confidence levels of the images, including: the VQGAN generates the images based on the input textual description, and the VQGAN determines logits values of each of the images and converts the logits values of each of the images into a probability distribution via a softmax function, wherein the softmax function is represented by the following formula (7):

$$softmax ( {z}_{i} ) = \frac{{e}^{{z}_{i}}}{{\sum }_{j} {e}^{{z}_{i}}} , \qquad ( 7 )$$

wherein in formula (7), zᵢ represents an i-th logits value, a maximum value in the probability distribution is designated as a confidence level of the image, and an average value of confidence levels of the images is determined, the confidence level is determined using the following formula (8):

$$confidence = \frac{1}{N} {\sum }_{i = 1}^{N} max ( softmax ( {logits}_{i} ) ) , \qquad ( 8 )$$

wherein in formula (8), N denotes a count of samples, and logitsᵢ denotes the logits value of an i-th sample. Dynamically adjusting the count of prototypes based on the confidence levels and a training stage includes: if the final confidence level of the generated images is lower than a confidence level threshold, increasing the count of prototypes, and when the count of prototypes reaches the maximum value and the training progresses to a certain stage, decreasing the count of prototypes. The count of samples refers to a count of images generated by the model in a training process and used for the confidence analysis, and the count of prototypes is a network structure parameter, i.e., a total count of prototype vectors currently maintained for each category (or for the entire network). The prototype vector locates in a feature space and is configured to portray typical features of a category.

Text processing includes: ensuring that the input text is within a specified length range and converting the input text to an embedded representation. Assuming an input text is T. in the following formula (19), Pₜ denotes the positions of a plurality of words in the input text:

$${T}_{e m b} = {E}_{t} ( T ) + {P}_{t} . \qquad ( 19 )$$

Generation process includes: the model generates the image tokens step-by-step, determines the logits values in each step based on the current text and image tokens, and generates new tokens by sampling.

$$L = softmax ( {W}_{p} \cdot S ) , \qquad ( 20 )$$

wherein the formula (20) represents that the current sequence S is processed by a weight matrix Wₚ to obtain the logits values, which are then converted into the probability distribution via the softmax function, sampled to select a next token and add it to the sequence. The generation process is repeated until a complete image token sequence is generated.

The image token sequence refers to an ordered collection of numerical vectors generated by the image encoder after processing the image. For example, the image token sequence may include a textual feature vector, a shape element vector, a color and luminance pattern vector, a simple object component vector, or the like.

In some embodiments, in response to determining that the probability distribution of different tokens during the image token generation process satisfies a preset distribution requirement, the processor determines that the reliability of the image tokens is low. For image tokens with low reliability, the processor selects the top M tokens in descending order of probability, generates at least one complete image token sequence and a corresponding remote sensing image, and highlights the positions of the tokens on the remote sensing image.

The probability distribution of different tokens refers to probability values corresponding to all tokens output by the model. In some embodiments, during the image token generation process, the model may output probability values for tokens associated with a plurality of possible geographic feature types. These probability values collectively form the probability distribution of different tokens. In some embodiments, the probability distribution may be represented as a probability distribution vector of length n (a total count of token types), such as P=[P₁, P₁, . . . , Pᵢ, . . . , Pₙ], wherein, the i-th element Pᵢ represents a probability that a specific position in the remote sensing image belongs to the i-th token category.

The preset distribution requirement refers to criteria used to determine whether image tokens are in a low-reliability state. In some embodiments, the preset distribution requirement may include that a difference between the maximum and minimum probabilities in the probability distribution is below a preset threshold. For example, when the difference between the maximum and minimum probabilities in the probability distribution is less than 0.3, the probability distribution is considered flat, and the image tokens are determined to have low reliability. The preset threshold may be configured by those skilled in the art based on practical requirements.

In some embodiments, for image tokens identified as having low reliability, the processor may select the top M tokens ranked in descending order of probability to generate at least one complete image token sequence and its corresponding remote sensing image, and highlight the positions of the tokens on the remote sensing image, wherein M may be empirically configured by those skilled in the art. For illustrative purposes, the value range of M may be (0-Z), where Z represents the total count of tokens.

In some embodiments, for image tokens determined to have low reliability, the processor selects the top M tokens sorted in descending order of probability; records both the positions of these M tokens within the sequence and their corresponding token values; and generates one or more complete image token sequences through permutation and combination of the selected M tokens. For example, for the sequence (A, B, C, D, E), the probability distribution of position D is ((D1, 40%), (D2, 60%)), and the probability distribution of position E is ((E1, 50%), (E2, 50%)). The processor may perform combinatorial permutation on D1/D2 and E1/E2, producing four variant pairs as (D1, E1), (D1, E2), (D2, E1), (D2, E2), and generate four complete image token sequences as (A, B, C, D1, E1), (A, B, C, D1, E2), (A, B, C, D2, E1), and (A, B, C, D2, E2).

In some embodiments, the processor may generate a corresponding remote sensing image from image token sequences, and highlight positions of low-reliability tokens on the corresponding remote sensing image. For example, the processor may utilize the decoder network to convert the image token sequence into image pixel values, and generate the remote sensing image through a series of post-processing operations. The post-processing operations may include performing operations such as color correction, contrast enhancement, sharpening, etc., on the generated remote sensing image to optimize the visual quality and detail representation of the remote sensing image. During the generation process of the remote sensing image, the processor may highlight positions corresponding to the low-reliability image tokens using specific markers (e.g., red bounding boxes) for users to identify and analyze areas with high model uncertainty.

Some embodiments of the present disclosure overcome the limitations of conventional generative models that produce single deterministic outputs. By explicitly transforming the inherent uncertainty of the model into a plurality of parallel generated results, a richer and more decision-referenced output is provided to the user. At the same time, it intuitively reveals regions with high model uncertainty, enhances the transparency of the generation process of the model, and improves the credibility of results, which helps users to make more informed and judicious assessments.

In S7, the remote sensing image may be generated using the trained VQGAN model.

In some embodiments, the operation S7 includes: after processing through the hierarchical prototype layers, the VQGAN generates predicted image tokens Î={Î₁, Î₂, . . . , Îₘ}, and a generation process is expressed as Î=f(S), wherein f denotes a generation function of the VQGAN, and S denotes the concatenated joint sequence. A cross-entropy loss is determined between the predicted image tokens and original image tokens, and the cross-entropy loss is used to measure a difference between a predicted token and a true token. The cross-entropy loss is defined as the following formula (9):

$$L = - {\sum }_{i = 1}^{C} {y}_{i} log ( {\hat{y}}_{i} ) , \qquad ( 9 )$$

wherein in formula (9), yᵢ denotes a probability distribution of the original image tokens, ŷᵢ denotes a probability distribution of the predicted image tokens. The predicted image tokens may be input into a decoder network, which converts the predicted image tokens into image pixel values based on learned features, and generate the remote sensing image of high quality through a series of post-processing operations. The original image token refers to an image token obtained by converting the input image using a pre-trained image encoder.

Image decoding includes: new data is generated by learning the latent distribution of the data and the generated image tokens are converted to a final image by the image decoder. The decoding process is represented by the following formula (21):

$${I}_{d e c o d e d} = vae . decoded ( I ) , \qquad ( 21 )$$

wherein in formula (21), vae.decoded represents a decoder function of the Variational Autoencoder (VAE), which functions to convert the representation I in the latent space into the final image I_{decoded}.

Determining probability distribution includes: evaluating the confidence level of the generated images by determining the logits values of each of the generated images, and determining the probabilities via the softmax function.

By calling the compute_logits function and inputting the text and image data, the logits values are determined by the following formula (22):

$$logits = f ( T , I ) , \qquad ( 22 )$$

wherein in formula (22), T represents the input text data, which is typically embedded into a vector space after preprocessing, and I represents the input image data, which may be a single image or a collection of a plurality of images, and is typically converted to feature vectors after preprocessing.

The logits values are original scores of an output layer of the neural network before applying an activation function. Assuming that the logits values are L, which are converted into a probability distribution P via the softmax function, and the calculation of the probability distribution is represented by the following formula (23):

$$P = softmax ( L ) . \qquad ( 23 )$$

Evaluating confidence level includes: the confidence level represents a certainty degree evaluated by the model that a generated image belongs to a specific category. The confidence level is evaluated by selecting the maximum value in the probability distribution P, and the formula (24) is:

$$confidence = max ( P ) . \qquad ( 24 )$$

The method for generating a remote sensing image from a text provided in some embodiments of the present disclosure, further includes: obtaining remote sensing images generated by the VQGAN based on a preset time interval; determining defective features of the remote sensing images based on the remote sensing images generated by the VQGAN; determining a plurality of supplemental acquisition parameters based on the defective features; generating supplemental acquisition instructions based on the supplemental acquisition parameters and controlling an image acquisition device to perform supplemental image acquisition; and training the dynamic hierarchical prototype block with an incremental manner based on the acquired supplemental images.

The preset time interval refers to a time interval used to periodically acquire remote sensing images generated by the VQGAN. For example, the preset time interval may be one week. In some embodiments, the preset time interval may be set in advance by a person skilled in the art according to actual application scenarios and needs.

In some embodiments, the processor may obtain the remote sensing images from a database based on the preset time interval. The database may be a system or platform for storing the remote sensing images and associated attribute information of the remote sensing images. The database may consist of historical data, real-time acquisition data, and other relevant data.

For example, if the preset time interval is one week, the processor may retrieve the remote sensing image data generated by the VQGAN from Day 1 to Day 7 from the database on Day 7; the processor may retrieve the remote sensing image data generated by the VQGAN from Day 8 to Day 14 from the database on Day 14, or the like.

The defective feature refers a difference between the geographic feature type in the remote sensing image generated by the VQGAN and a real-world or expected target. For example, the defective feature may include a clarity defect, a detail loss defect, a boundary confusion defect, and a perspective distortion defect. More descriptions regarding the geographic feature type may be found in the operation S3 and related descriptions thereof.

The clarity defect refers that an edge of a geographic feature in the remote sensing image generated by the model is blurred, a texture of the geographic feature is not clear, and the whole or part of the remote sensing image is in a state of “blurring”. For example, the edges of mountains are blurred and textures are not clear.

The detail loss defect refers that the fine structures of the geographic feature (e.g., mountain folds, lake ripples, building windows, etc.) in the remote sensing image generated by the model are missing or incomplete, resulting in the loss of feature information and texture smoothing of the target object. For example, lake ripples are missing or incomplete.

The boundary confusion defect refers that a boundary between different geographic feature types is unclear, where contours of adjacent objects blend together and cannot be distinctly differentiated. For example, the boundary between a lake and its shore is blurred, a boundary between a high-rise building and the sky is unclear, or the like.

The perspective distortion defect refers to the deviation of the geographic shape of the geographic feature in the remote sensing image generated by the model from the real world, such as the deformation of objects due to the shooting angle and projection transformation. For example, tall buildings are tilted, the contours of mountains are distorted, or the like.

In some embodiments, the processor may determine the defective feature of the remote sensing image in a plurality of manners based on the remote sensing image generated by the VQGAN.

In some embodiments, for the clarity defect, the processor may perform a grayscale conversion on the remote sensing image, obtain a gradient map via a Laplace operator or a Sobel operator, and compute a variance of pixel values of all the remote sensing images. In response to determining that the variance is below a first threshold, the processor may determine that the remote sensing image has the clarity defect. The first threshold may be manually preset based on experience or experimentation.

In some embodiments, for the detail loss defect, the processor may determine an LBP feature map of the remote sensing image generated by the VAGAN, and determine a count of non-zero terms of a histogram. In response to determining that the count of non-zero terms is below a second threshold, the processor may determine that the remote sensing image has a detail loss defect. The second threshold may be manually preset based on experience or experimentation.

In some embodiments, for the boundary obfuscation defect, the processor may randomly select a plurality of points on a boundary line of the remote sensing image, extract pixel intensity profile lines spanning the boundary along normal directions of the plurality of points, and determine an average value of a maximum gradient value of each pixel intensity profile line. In response to determining that the average value is below a third threshold, the processor may determine that the remote sensing image has a boundary confusion defect. The third threshold may be manually preset based on experience or experimentation.

In some embodiments, for the perspective distortion defect, the processor may use Hough Transform or LSD algorithm to detect all straight line segments in the remote sensing image generated by the VAGAN, and perform a parallel verification and a vertical verification. In the parallel verification, the processor may group the detected straight line segments by angle to determine an angular variance of the straight line segments within the same group; in the vertical verification, the processor may identify pairs of straight line segments with an angular difference of close to 90° to determine an angular difference of each pair of straight line segments. In response to determining that the angular variance or angular difference is greater than a fourth threshold, the processor may determine that the remote sensing image has a perspective distortion defect. The fourth threshold may be manually preset based on experience or experimentation.

The supplemental acquisition parameter refers to a parameter related to the acquisition of supplementary images. In some embodiments, the processor may generate a supplemental acquisition instruction based on the supplemental acquisition parameter to control an image acquisition device to perform supplemental image acquisition, wherein the image acquisition device refers to a hardware device for acquiring real remote sensing images and/or supplemental images. For example, the image acquisition device may include an unmanned aerial vehicle (UAV) drone, etc. A supplemental image refers to a real remote sensing image that is reacquired.

In some embodiments, the supplemental acquisition parameter may include an acquisition location, an acquisition attitude, an acquisition height, an acquisition amount, and an acquisition time period.

The acquisition location refers to a geographic location to be reached by the image acquisition device. In some embodiments, the acquisition location may be a latitude and longitude range of the target geographic feature.

The acquisition attitude refers to the spatial orientation of the image acquisition device (e.g., UAV) at the moment of image acquisition. In some embodiments, the acquisition attitude may be defined by three rotation angles, i.e., a pitch angle, a roll angle, and a yaw angle. The pitch angle refers to an upward or downward tilt angle of the head of a device relative to the horizontal plane. The roll angle refers to a rotation angle of the device around its front and rear axis. The yaw angle refers to a rotation angle of the head of the device relative to the due north direction. For example, the acquisition attitude may include a pitch angle −45° (indicating a 45° downward tilt angle of the head of the device), a roll angle 0° (indicating the device is placed horizontally), and a yaw angle 90° (indicating that the head of the device is facing in the due east direction).

The acquisition height refers to a distance of the image acquisition device from the surface where the target geographic feature is located or from the sea level.

The acquisition amount refers to a total count of images acquired for a particular acquisition target or region during an acquisition task.

The acquisition time period refers to a time range in which the image acquisition device performs an image acquisition task.

In some embodiments, the processor may determine the supplemental acquisition parameter based on the defective feature via a preset table. For example, the processor may determine the supplemental acquisition parameter based on the geographic feature type, the defect feature, and the current acquisition parameter via the preset table. The preset table includes a plurality of sets of correspondences between the geographic feature types, the defect features, the current acquisition parameters, and the supplemental acquisition parameters. In some embodiments, the preset table may be constructed based on historical data. For example, the processor may perform supplemental image acquisition for defective remote sensing images in historical data using a plurality of sets of different supplemental acquisition parameters. After incremental training with the plurality of sets of supplemental images, the processor may determine a corresponding relationship group consisting of supplemental acquisition parameters under which no defective features in the supplemental images, the corresponding geographic feature types, original defective features, and original acquisition parameters.

For example, if the remote sensing image of a lake has the clarity defect or the detail loss defect, the acquisition height may be reduced while maintaining a vertical overhead acquisition attitude to obtain a clearer image; if the remote sensing image of a land-water boundary has the boundary confusion defect, the acquisition height may be lowered to get closer to the land-water boundary, and the acquisition time period may be adjusted to a time period when the water surface reflection is weak to enhance boundary contrast; if the remote sensing image of a high building has the perspective distortion defect, the pitch angle of the acquisition attitude may be adjusted from the current −60° to −40°, and the acquisition amount may be appropriately increased.

The supplemental acquisition instruction refers to an instruction configured to control the image acquisition device for supplemental image acquisition.

In some embodiments, the processor may generate the supplemental acquisition instruction based on the supplemental acquisition parameter by a preset program and send the supplemental acquisition instruction to the image acquisition device. The preset program may be set in advance by a person skilled in the art.

In some embodiments, in response to receiving the supplemental acquisition instruction, the image acquisition device may perform supplemental image acquisition based on the supplemental acquisition parameter.

In some embodiments, the processor may incrementally train the dynamic hierarchical prototype blocks in accordance with the operation S1-operation S7 based on the acquired supplemental images. More descriptions regarding the operation S1-operation S7 may be found in FIG. 1-FIG. 2 and related descriptions thereof.

In some embodiments of the present disclosure, by determining the supplemental acquisition parameter and generating the supplemental acquisition instruction based on the defective features, the ability of the model closure to iterate and optimize itself is improved. The process is able to automatically identify image defects, adjust the acquisition strategy accordingly, target the correction of its own defects, and acquire more targeted supplementary data. By constructing a feedback loop of “defect recognition-targeted acquisition-incremental training”, the efficiency and relevance of data acquisition and model training are significantly improved, and ensures that the fidelity and detail of the resulting images are consistently improved. At the same time, this approach improves the efficiency of data acquisition and model training, reduces the interference of invalid data, and ensures the accuracy and reliability of the generated images.

In some embodiments, the supplemental acquisition parameter further includes an imaging parameter. The imaging parameter refers to a parameter that is set by the image acquisition device when acquiring an image. For example, the imaging parameter may include an aperture size, a shutter speed, an ISO sensitivity, etc.

In some embodiments, the method for generating a remote sensing image from a text may further includes: determining the imaging parameter of the image acquisition device based on the geographic feature type, token features of the image tokens, and environment data; and generating a parameter adjustment instruction based on the imaging parameter for controlling the imaging parameter of the image acquisition device when performing acquisition of the geographic feature type.

The image token refers to a digital vector that is output by the image encoder after processing an image block. The digital vector may include information such as texture features, shape elements, color and luminance patterns, simple object parts, or the like. The texture feature may be ripples on water surface, canopy texture of a forest, stripes of a farmland, repeating units of a building, or the like. The shape element may be short line segments, corner points, simple curves, etc., that form the edge of an object. The color and luminance pattern may be average colors, color gradients, luminance contrasts, etc., in local regions. The simple object part may be a simple part corresponding to a more semantic part, such as a corner of a roof, a part of a wheel, a tree branch, etc.

The token feature refers to a quantitative attribute or a feature value of an image token, which is used to measure the prominence and differentiation of the token. In some embodiments, the token feature may be a texture roughness score of the image token determined by a grayscale covariance matrix, or a count of straight lines detected by a Hough Transform, or shape information extracted by an LSD algorithm, or the like.

The environment data refers to data related to the image acquisition environment. For example, the environment data may include a light intensity, a wind speed, or the like. In some embodiments, the light intensity may be captured by a light sensor (e.g., a photoresistor) provided on the image acquisition device, and the wind speed may be captured by an anemometer sensor provided on the image capture device.

In some embodiments, the processor may determine the imaging parameter of the image acquisition device based on the geographic feature types, the token features of the image tokens, and the environment data via a vector database.

The vector database may be configured to store a plurality of feature vectors and labels corresponding to the feature vectors. The feature vectors may be generated based on historical geographic feature types, historical token features (i.e., token features of the image tokens before adjusting the imaging parameters), and historical environment data. The labels corresponding to the feature vectors may be the imaging parameters. In some embodiments, for a certain feature vector, the processor may select the imaging parameter of the remote sensing image with a good imaging effect after adjusting the imaging parameter from historical data as the label corresponding to the feature vector. The good imaging effect may be understood as an image parameter of the remote sensing image meeting a preset quality threshold. The image parameter may include clarity, contrast, color reproduction, or the like. In some embodiments, the processor may determine a remote sensing image whose image parameter, such as the clarity, the contrast, the color reproduction, or the like, satisfy the preset quality threshold as having good imaging effect. The preset quality threshold may be set by a person skilled in the art based on practical needs.

In some embodiments, the processor may construct a vector to be matched based on the current geographic feature type, current token features of the image tokens, and current environmental data, and determine a similarity between the vector to be matched and each of a plurality of feature vectors. The processor may set the label corresponding to the feature vector with the highest similarity as the imaging parameter corresponding to the vector to be matched. The manner of determining the similarity may include, but is not limited to, a cosine similarity, a Euclidean distance, or the like.

It should be noted that when determining the vector to be matched, the processor may convert each feature parameter (e.g., the geographic feature type, the environment data) to a dimensionless form. For a discrete feature, the processor may use an algorithm such as one-hot coding when it needs to convert data from different categories into numerical form. The discrete feature refers to a feature that may be divided into different, discrete categories, such as the geographic feature type. For a continuous feature, the processor may perform normalization when it needs to scale feature values to a uniform range. The continuous feature refers to a feature that can take continuous values within a certain range, such as environment data.

The parameter adjustment instruction refers an instruction for directing the image acquisition device to adjust the imaging parameter.

In some embodiments, the processor may generate a parameter adjustment instruction based on the imaging parameter by a preset program and send the parameter adjustment instruction to the image acquisition device. In response to receiving the parameter adjustment instruction, the image acquisition device may automatically adjust the parameter settings to match the imaging parameter.

In some embodiments of the present disclosure, the imaging parameter is determined through the geographic feature type, token features of the image tokens, and environment data, thereby achieving refined regulation of the imaging process. This regulation establishes a direct feedback between the semantic understanding of the model and physical acquisition equipment, which improves the quality and information density of supplemental data from the source, and enables the model to more efficiently distinguish easily confused geographic feature characteristics.

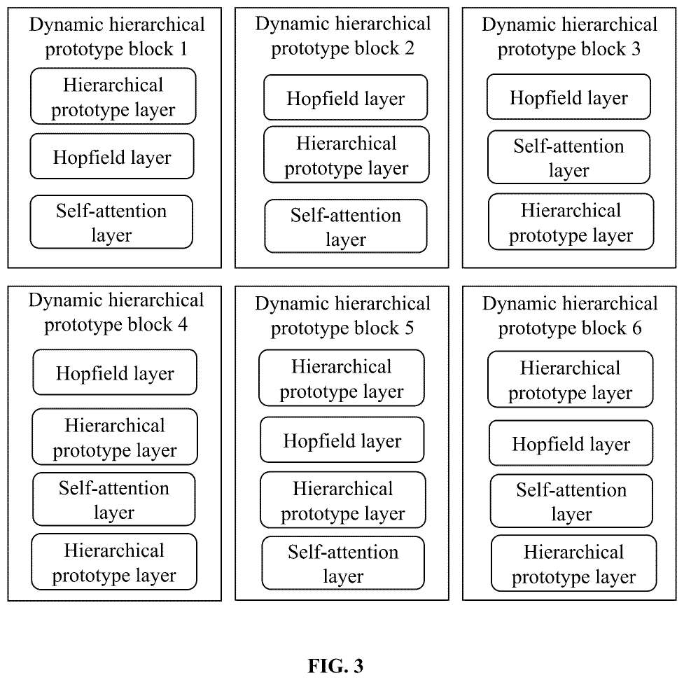

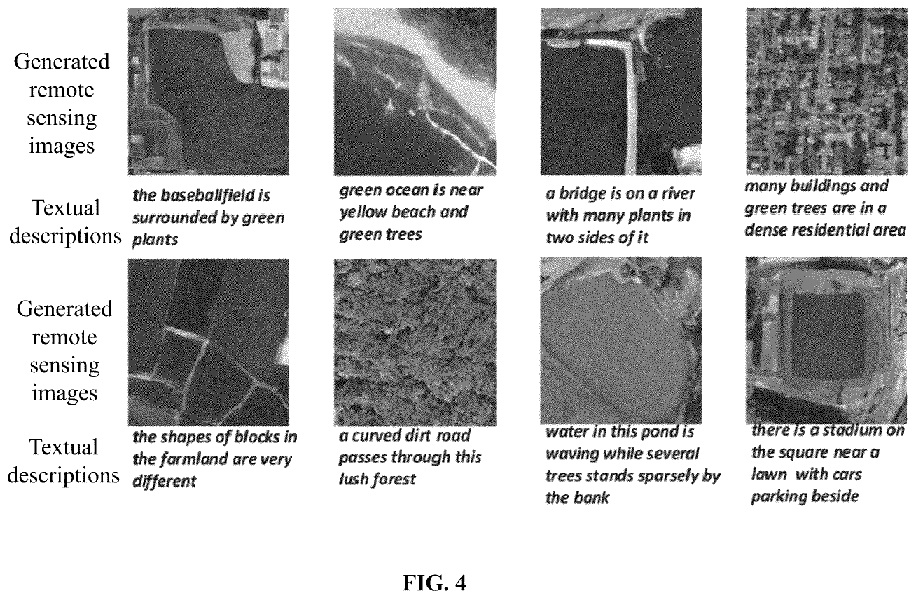

FIG. 3 is a schematic diagram illustrating an exemplary dynamic hierarchical prototype block in a process for generating a remote sensing image from a text according to some embodiments of the present disclosure. FIG. 4 is a schematic diagram illustrating an exemplary remote sensing image generated in a process for generating a remote sensing image from a text according to some embodiments of the present disclosure. The method for generating a remote sensing image from a text provided in some embodiments of the present disclosure, was trained on 1 piece of NVIDIA RTX A6000 and 1 piece of NVIDIA RTX 4090 graphics cards. The count of the dynamic hierarchical prototype blocks was fixed at 10, and the model was trained for 1000 epochs with a batch size of 16. As the plurality of sets of generated remote sensing images and their corresponding textual descriptions shown in FIG. 4, the results demonstrate that the method provided by the embodiments of present disclosure produces higher-quality remote sensing images with improved detail preservation and structural accuracy of geographic features, yielding outputs that more closely resemble real remote sensing images.

TABLE 1

| Prototype block variants | IS↑ | FID↓ | OA↑ |
|---|---|---|---|
| Dynamic hierarchical prototype block 1 | 6.50 | 94.66 | 65.03 |
| Dynamic hierarchical prototype block 2 | 6.65 | 98.10 | 64.17 |
| Dynamic hierarchical prototype block 3 | 6.39 | 95.18 | 66.65 |
| Dynamic hierarchical prototype block 4 | 7.01 | 95.12 | 68.52 |
| Dynamic hierarchical prototype block 5 | 6.85 | 92.03 | 68.45 |
| Dynamic hierarchical prototype block 6 | 7.00 | 91.65 | 68.89 |
| Basic prototype block | 5.83 | 115.96 | 55.45 |

FIG. 3 shows various variants of dynamic hierarchical prototype blocks. As shown in Table 1, the hierarchical prototype layers provided in some embodiments of the present disclosure significantly improve the performance of the model. No matter which layer of the basic prototype block the hierarchical prototype layers are introduced into, the accuracy and robustness of the model can be enhanced. In particular, after adding a plurality of hierarchical prototype layers, the quality and details of the generated images are significantly improved, which verifies its effectiveness and applicability in the task of text-to-remote sensing image generation.

TABLE 2

RSICD

| Method | OA↑ | IS↑ | FID↓ |
|---|---|---|---|
| Base | 65.72 | 5.99 | 102.44 |
| Base + dynamic prototype | 67.92 | 6.73 | 88.07 |
| learning strategy-a | | | |
| Base + dynamic prototype | 67.14 | 7.10 | 92.20 |
| learning strategy-b | | | |
| Base + dynamic prototype | 66.80 | 6.51 | 96.73 |
| learning strategy-c | | | |
| Base + dynamic prototype | 68.45 | 6.52 | 94.08 |
| learning strategy-d | | | |

Table 2 presents quantitative results regarding the impact of different dynamic prototype learning strategies on the model. The dynamic prototype learning strategies are classified into four categories: 1. dynamic prototype learning strategy-a: a confidence-based prototype adjustment strategy; 2. dynamic prototype learning strategy-b: a training progress-based prototype adjustment strategy; 3. dynamic prototype learning strategy-c: a fixed-interval-based prototype adjustment strategy; 4. dynamic prototype learning strategy-d: a stage-based prototype adjustment strategy. The results demonstrate that the models incorporating dynamic prototype learning strategies outperform the baseline model across all evaluation metrics, with lower cross-entropy loss, indicating better convergence during the training process and significant improvements in IS and FID scores.

The present disclosure proposes addresses the problem of difficulty in generating high-quality and realistic remote sensing images from textual descriptions, and provides a method for generating a remote sensing image from a text. I Experiments were conducted on the RSICD dataset, and significant improvements were observed in the IS metric, FID metric, and zero-shot classification accuracy (OA). Overall, the model exhibits excellent performance in terms of quality of the generated images and handling of unseen data, particularly achieving a leading position in zero-shot classification accuracy. Furthermore, the model differs from traditional GAN-based methods and instead employs a Transformer-based method. The Transformer-based method has unique advantages in processing sequence data and capturing long-range dependencies, which may be one of the reasons for the superior performance of the model in zero-shot classification tasks.

Some embodiments of the present disclosure include, but not limited at least the following beneficial effects.

By introducing hierarchical prototype layers and a confidence-driven dynamic prototype learning strategy, the richness and accuracy of remote sensing image feature representation are enhanced. The model can gradually learn and adapt to more prototypes, exhibiting higher robustness and accuracy when processing complex data. The advantages and effects are as follows.

1. The method provided by some embodiments of the present disclosure is designed with a hierarchical prototype layer, which combines a plurality of Hopfield layers and self-attention layers to capture richer feature representations. Specifically, the hierarchical structure of the hierarchical prototype layer can capture more complex features and relationships; in particular, when the plurality of hierarchical prototype layers are added, the impact on the generation capability of the model is particularly significant, which is manifested in the significant improvement in the quality and details of the generated images.

2. The method provided by some embodiments of the present disclosure is designed with a dynamic prototype learning strategy, which overcomes the drawback of traditional methods where the count of prototypes is fixed and cannot adapt to the model needs during the training process. The method provided in the present disclosure enables the model to have adaptive learning capability by dynamically adjusting the count of prototypes according to confidence and training stages during the training process. Experimental results show that the method of dynamically adjusting the count of prototypes outperforms the method with a fixed count of prototypes in a plurality of evaluation metrics, and the quality of the generated images is significantly improved.

3. The method provided by some embodiments of the present disclosure introduces the Hopfield layers with a temperature parameter, enabling it to more flexibly adjust the smoothness of the normalized exponential function, thereby allowing for a more stable memory and retrieval process.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

What is claimed is:

1. A method for generating a remote sensing image from a text, comprising:
S1, preparing a remote sensing image captioning dataset (RSICD), obtaining a textual description and a real remote sensing image corresponding to the textual description;
S2, training a vector quantization generation adversarial network (VQGAN);
S3, encoding text-image pairs through a text encoder and an image encoder;
S4, concatenating text tokens and image tokens;
S5, inputting a concatenated joint sequence into dynamic hierarchical prototype blocks for feature extraction, including:
inputting the concatenated joint sequence into a first dynamic hierarchical prototype block for normalization and scaling; inputting a normalized and scaled concatenated joint sequence into Hopfield layers with a temperature parameter; inputting a concatenated joint sequence processed by the Hopfield layers into hierarchical prototype layers, wherein the hierarchical prototype layers are represented by the following formula:
$$H i e r a r c h i c alPrototypeLayer ( e ) = S {A}_{2} ( {H}_{2} ( S {A}_{1} ( {H}_{1} ( x ) ) ) ) , \qquad ( 1 )$$
where H₁ represents a first Hopfield layer, H₂ represents a second Hopfield layer, SA₁ represents a first self-attention layer, SA₂ represents a second self-attention layer;
each of the dynamic hierarchical prototype blocks includes two hierarchical prototype layers, two standard Hopfield layers, and two self-attention layers, which is represented by the following formula:
$$P ( x ) = x + {\sum }_{i = 1}^{{n}_{blk}} ( L {S}_{i} ( P N ( H L ( x ) ) ) + H P L ( x ) + L {S}_{i} ( P N ( S A ( x ) ) ) + H P L ( x ) ) , \qquad ( 2 )$$
where P represents the dynamic hierarchical prototype blocks, LS represents a LayerScale layer, PN represents a PreNorm layer, HL represents the Hopfield layers, HPL represents the hierarchical prototype layers, SA represents the self-attention layers, n_{blk} represents a count of prototypes; and
inputting the concatenated joint sequence processed by the first dynamic hierarchical prototype block into subsequent dynamic hierarchical prototype blocks sequentially;
S6, using a dynamic prototype learning strategy during the training of the VQGAN; and
S7, generating the remote sensing image using the trained VQGAN.

2. The method of claim 1, wherein in S2,
a Codebook Z of discrete values is pre-generated, the Codebook Z is represented by
$$Codebook 𝒵 = {\{ {z}_{k} \}}_{k = 1}^{K} ,$$
wherein zₖ∈ [symbol] ⁿ^{_{z}}, and
for each coding position of \hat{z}, a code with a shortest distance to the each coding position is identified in the Codebook Z, and encoding is performed using a CNN Encoder, represented by:
$$\hat{x} = G ( {z}_{q} ) = G ( q ( E ( x ) ) ) . \qquad ( 3 )$$

3. The method of claim 1, wherein in S3, each character in the text is designated as an independent token, frequencies of all character pairs are determined, most frequent character pairs are merged to form a new token, and the above operations are repeated until a preset token count is reached;
let n denotes a maximum length of an input sentence, if a word count of an input text description is less than n, zero is used as a placeholder to pad empty tokens, and the text tokens are converted into vector representations using a pre-trained word embedding model; and
an input image is converted into the image tokens using a pre-trained image encoder, and the image tokens are converted into vector representations.

4. The method of claim 1, wherein in S4, the text tokens and the image tokens are concatenated in an order in which the text tokens precede the image tokens, to form the concatenated joint sequence, and a positional encoding is added to each token in the concatenated joint sequence.

5. The method of claim 1, wherein in S6, during the training of the VQGAN, the VQGAN periodically generates images and determines a final confidence level of the images, including:
the VQGAN generating the images based on the textual description;
the VQGAN determining logits values of each of the images;
the VQGAN converting the logits values of each of the images into a probability distribution via a softmax function, wherein the softmax function is represented by the following formula:
$$softmax ( {z}_{i} ) = \frac{{e}^{{z}_{i}}}{{\sum }_{j} {e}^{{z}_{i}}} , \qquad ( 4 )$$
where zᵢ represents an i-th logits value, a maximum value in the probability distribution is designated as a confidence level of the image, and an average value of confidence levels of the images is determined, the confidence level is determined using the following formula:
$$confidence = \frac{1}{N} {\sum }_{i = 1}^{N} max ( softmax ( {logits}_{i} ) ) , \qquad ( 5 )$$
where N denotes a count of samples, and logitsᵢ denotes the logits value of an i-th sample;
the VQGAN dynamically adjusting the count of prototypes based on the confidence levels and a training stage:
if the final confidence level of the images is lower than a set confidence level threshold, increasing the count of prototypes, or
if the count of prototypes reaches the maximum value and the training progresses to a preset stage, decreasing the count of prototypes.

6. The method of claim 1, wherein in S7,
after processing through the hierarchical prototype layers, the VQGAN generates predicted image tokens Î={Î₁, Î₂, . . . , Îₘ}, and a generation process is expressed as Î=f(S),
where f denotes a generation function of the VQGAN, and S denotes the concatenated joint sequence;
a cross-entropy loss is determined between the predicted image tokens and original image tokens, the cross-entropy loss is defined as:
$$L = - {\sum }_{i = 1}^{C} {y}_{i} log ( {\hat{y}}_{i} ) , \qquad ( 6 )$$
where yᵢ denotes a probability distribution of the original image tokens, ŷᵢ denotes a probability distribution of the predicted image tokens; and
the predicted image tokens are converted into image pixel values through a decoder network to generate the remote sensing image of high quality.
